(19) United States
(12) Patent Application Publication
(10) Pub. No.: US 2026/0368302 A1
(43) Pub. Date: Nov. 19, 2026

(54) SECURITY TECHNIQUES FOR AGENT TO AGENT COMMUNICATIONS

(71) Applicant: Salesforce, Inc., San Francisco, CA (US)

(72) Inventors: Alvaro Alcedo Moreno, Madrid (ES); Luis Campo Giralte, Madrid (ES)

(21) Appl. No.: 19/210,741

(22) Filed: May 16, 2025

(51) Int. Cl. G06F 21/44; G06F 21/57

(52) U.S. Cl. CPC G06F 21/44; G06F 21/57

(57) ABSTRACT

An artificial intelligence (AI) based security agent associated with a database system may assist one or more AI based user agents to reduce security issues in agent to agent communication. For example, the security agent may be trained to monitor communications between one or more user agents and one or more external agents, and may perform actions to reduce security issues for the one or more user agents. In some cases, the actions may include inserting prompt features that request information from the external agent into communications from the user agents, performing open source intelligence (OSINT) verification operations, communicating with the external agent as a third party, or recommending whether the first agent should continue or end the transaction. The security agent may determine a trust score for the external agent and may suggest to the user agent to end communications with the external agent based on the trust score.

### FIELD OF TECHNOLOGY

The present disclosure relates generally to database systems and data processing, and more specifically to security techniques for agent to agent communications.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cases, a data system (e.g., a set of servers, a cloud platform, a computer) may support or implement one or more artificial intelligence (AI) agents, which may be referred to herein as agents. In some cases, a user associated with an AI system may utilize one or more user agents (e.g., AI agents associated with the user) to negotiate transactions by communicating with agents that are external to the data system (e.g., external agents, agents supported by a second or different data system). Such communications may be referred to as agent to agent communications and may be text based or another form of signaling understandable by a computer. In some cases, each user agent may be specifically trained to negotiate transactions for a single use case (e.g., transaction type, such as vehicle purchases, vacation planning, real-estate transactions, business contracts, etc.), which may improve an ability of the user agent to comprehend inputs and generate outputs associated with the single use case. Agent to agent communications may increase productivity for the user due to the automatic actions and relatively low latency associated with the user agents. However, malicious external agents may use agent to agent communications in such a way that increases security risks for the user, such as by exposing user data, causing the user agent to generate harmful output, or scamming the user agent into a malicious transaction (e.g., falling for a scam, buying a false product, wasting user money or other user resources). In some cases, training and using each user agent to also recognize and reduce security issues may utilize more resources at the associated data system such as memory, processing resources, and power, and may reduce the ability of the user agent to generate effective outputs and comprehend inputs associated with a respective use case.

### BRIEF DESCRIPTION OF THE DRAWINGS

FIG. 1 illustrates an example of a data processing system that supports security techniques for agent to agent communications in accordance with aspects of the present disclosure.

FIG. 2 shows an example of a process flow that supports security techniques for agent to agent communications in accordance with aspects of the present disclosure.

FIG. 3 shows an example of a process flow that supports security techniques for agent to agent communications in accordance with aspects of the present disclosure.

FIG. 4 shows a block diagram of an apparatus that supports security techniques for agent to agent communications in accordance with aspects of the present disclosure.

FIG. 5 shows a block diagram of a security module that supports security techniques for agent to agent communications in accordance with aspects of the present disclosure.

FIG. 6 shows a diagram of a system including a device that supports security techniques for agent to agent communications in accordance with aspects of the present disclosure.

FIG. 7 shows a flowchart illustrating methods that support security techniques for agent to agent communications in accordance with aspects of the present disclosure.

### DETAILED DESCRIPTION

Some data systems may support agents (e.g., artificial intelligence (AI) agents), which may be a type of AI system capable of understanding and responding to inquiries without human intervention (e.g., as opposed to traditional AI that may use human input for specific tasks), as well as automatically improving performance of one or more tasks through self-learning. For example, an agent may include one or more AI or machine learning (ML) tools, such as a large language model (LLM), a neural network, or other ML algorithms, and may be trained to negotiate transactions (e.g., deals, purchases, agreements) for a user by receiving and processing inputs and generating outputs to finalize a transaction. In some cases, agents from different systems (e.g., supported or implemented on different servers, computers, or machine systems) may communicate with each other to negotiate a transaction, where such communications may be referred to as agent to agent communications. For example, a user may be associated with a system (e.g., a computer, a software, one or more servers) that supports a first agent (e.g., a user agent), and a company may be associated with a system that supports a second agent (e.g., an external agent, an agent external to the user and the user agent), and the first agent and the second agent may communicate to negotiate a transaction. For example, the user may specify one or more desired outcomes (e.g., requirements) for the transaction (e.g., price, shipping time, product attributes, brand, agreement clauses, or other features based on a business case associated with the transaction) to the first agent, and the first agent may contact the second agent to negotiate a transaction that fulfils the desired outcomes (e.g., satisfies the requirements). The agents may automatically interpret communications, determine a next step in the transaction, and transmit communications designed to effectuate the next step of the transaction, which may reduce latency in negotiating deals and may allow the customer or the company to negotiate and create a larger quantity of transactions in a given time while maintaining a quality of each transaction based on the desired outcomes.

Some agents may be trained to perform transactions for a respective business case, where a business case may be a type or category of transaction, such as mobile device purchases, real-estate purchases, legal contracts, travel plans, and investment deals, among other examples. Training an agent for a specific use case may improve the accuracy and speed of the transactions negotiated by the agent while reducing memory and processing resources used to train and operate the agent. For example, training and operating a single agent to perform transactions for a plurality of business cases may utilize more resources (e.g., memory, processing, power) and may reduce the ability of the agent (e.g., an AI system) to generate useful outputs for each business case.

In some cases, agent to agent communication may cause one or more security issues for a user. For example, a malicious external agent may use one or more techniques to confuse or manipulate a user agent to cause security issues, such as revealing sensitive information, outputting harmful information, falling for a scam transaction, or otherwise providing a negative experience for the user (e.g., or the company). In some cases, training each agent associated with a respective business case to also perform security operations or be cognizant of security issues may increase resources used to train and operate the agents as well as reduce a capability of each agent to generate useful outputs for a respective business case. Stated differently, training an agent for a respective business case (e.g., and not for identifying and resolving security issues) may reduce memory and processing resources used to train and operate the agent, but may also lead to an increase in security issues. Accordingly, techniques to improve security in agent to agent communication while maintaining reduced resource usage and a high output quality may be beneficial.

According to the techniques described herein, a security agent (e.g., “Cricket”) may assist one or more agents (e.g., user agents, external agents, buyer agents, seller agents) to reduce security issues. For example, the security agent may be trained to monitor agent to agent communications between a user agent and an external agent and may perform one or more actions to reduce security issues for the user agent. In some cases, the one or more actions may include providing prompt features (e.g., text, words, phrases, sentences, pre-configured scripts) to the first agent for requesting information from the second agent, performing verification operations (e.g., open source intelligence (OSINT) operations) associated with the external agent, communicating with the external agent as a third party, providing a transaction continuance recommendation that indicates (e.g., commands, recommends) the user agent to continue or abort (e.g., purposefully terminate before completion) the transaction, or any combination thereof. Such techniques may increase security of user data by improving agent to agent communication technology, and may reduce computational and memory resources used to train and operate the user agent.

The security agent may receive information from various sources to assist the user agent before, during, and after negotiation of a transaction with the external agent. In some cases, the various sources may include a database that stores agent identifiers (IDs) of external agents and corresponding trust metrics (e.g., trust scores, validation metric, security metric) developed from previous transaction with the external agents, OSINT sources, communications sent between the user agent and the external agent, an internet search engine, or any combination thereof. For example, the security agent may generate (e.g., or update) a trust metric associated with the external agent based on the received information, and, if the trust metric falls below a threshold value at any point during the transaction, the security agent may suggest to (e.g., command) the first agent to end (e.g., abandon) the transaction or transmit a prompt feature generated (e.g., at least in part) by the security agent. In some cases, the security agent may also assist multiple user agents in parallel (e.g., during a same duration, in overlapping durations, simultaneously) or in series, where the multiple user agents may include agents that are trained to negotiate deals for different business cases. As one security agent may be trained and operated for a plurality of agents that are not trained in security, a system supporting multiple agents that implements the techniques described herein may use fewer resources to train and operate the agents (e.g., including the security agent) while maintaining high security of data and improved outputs from the user agents to negotiate transactions.

Aspects of the disclosure are initially described in the context of an environment supporting an on-demand database service. Aspects of the disclosure are also described with reference to process flow diagrams illustrating techniques (e.g., algorithms, steps) related to security techniques for agent to agent communications. Aspects of the disclosure are further illustrated by and described with reference to apparatus diagrams, system diagrams, and flowcharts that relate to security techniques for agent to agent communications.

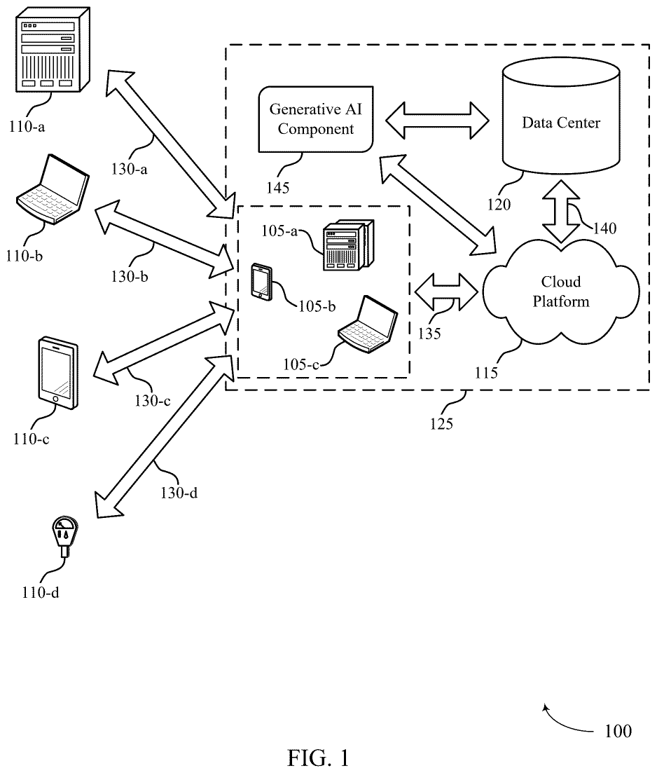

FIG. 1 illustrates an example of a system 100 for cloud computing that supports security techniques for agent to agent communications in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., computer resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Further, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Further, the AI technologies may be merged in a variety of implementations, for example, by bagging, boosting, stacking, etc. the AI technologies.

In some cases, one or more portions of the subsystem 125 may support or implement AI agents, which may be referred to as agents. For example, the generative AI component 145 of the subsystem 125 may include one or more agents, where the corpus of input data to train the agents, one or more weights or other data associated with the agents may be stored in the data center 120, the cloud platform 115, or both. In some cases, a user associated with a cloud client 105 (e.g., a user associated with the subsystem 125) may generate and use one or more agents in the subsystem 125 to negotiate transactions within one or more respective use cases. For example, the agent may be trained with a corpus of input data or additional data specific to the use case associated with the agent, such that the agent may comprehend inputs associated with the use case and generate effective outputs associated with the use case. In some cases, other subsystems 125 may support other agents (e.g., external agents), and the agents of the subsystem 125 may perform agent to agent communications with the other agents via wireless or wired means to negotiate transactions.

In some cases, agent to agent communication with external agents may cause one or more security issues at the subsystem 125 (e.g., the data center 120, the cloud platform 115, the cloud clients 105, the users). For example, a malicious external agent may manipulate or scam a user agent into revealing secure data in the subsystem 125, generating output that is harmful for the user, or otherwise falling for a scam (e.g., negotiating a deal that is not real or truthful). In some cases, training and operating each user agent to recognize and avoid security issues (e.g., in addition to negotiating transactions for a use case) may increase memory and processing resources used at the subsystem 125, reduce a quality (e.g., accuracy, relevance) of the user agent output for the business case, or both. Additionally, when the subsystem 125 implements multiple user agents, the increased resource draw may compound. Thus, techniques to improve security for agent to agent communications while saving resources and maintaining user agent output quality may be beneficial for the subsystem 125.

The techniques described herein may improve security and maintain reduced resource consumption for cloud clients 105-a (e.g., servers), the data center 120, and other computing systems of the subsystem 125 without compromising user agent output quality. For example, the subsystem 125 may implement one or more security agents (e.g., fewer than a quantity of user agents implemented at the subsystem 125) which may monitor agent to agent communications between user agents of the subsystem 125 and external agents. A security agent may be trained and operated to detect security issues based on communications from the external agent, OSINT verification operations, and data associated with the external agent and stored at the data center 120 or cloud platform 115. In some cases, the security agent may inject a prompt feature into a response from a user agent to request or verify information from the external agent, perform one or more OSINT verification operations associated with the external agent, and recommend (e.g., command) a user agent to continue or end a transaction with an external agent based on a trust metric associated with the external agent. As each security agent may be capable of monitoring and assisting multiple user agents, resources utilized at the subsystem 125 to train and operate the security agent may be less than training and operating each user agent to recognize and avoid security issues. Additionally, a quality of the user agent output may not be negatively impacted. That is, the techniques described herein may increase security and maintain user agent output quality for the subsystem 125 without substantially increasing resource usage for the subsystem 125.

As an example, a user may be associated with a system that supports one or more user agents. In some cases, a first user agent may be trained for negotiating transactions of a first use case, such as purchasing cellular phones, and a second user agent may be trained for negotiating transactions of a second use case, such as real estate purchases. Each of the user agents may be associated with higher quality output and reduced training and operating resources compared to a user agent trained to both negotiate transactions and reduce security issues. To further reduce resource usage associated with training and operating the user agents, a single security agent may be trained at the system to recognize security issues and recommend actions associated with security. In some cases, the user may input one or more desired outcomes to the first user agent (e.g., buy a phone that has 264 GB of storage and costs less than $800), and the first user agent may find a first external agent associated with cellular phones (e.g., indicated by the data center 120 based on previous transactions, via an internet search for external agents) to begin negotiating a transaction based on the desired outcomes. The user may also input one or more desired outcomes to the second user agent (e.g., place an offer under $350,000 on a two bedroom house in Seattle, WA), and the second user agent may find a second external agent associated with real estate to begin negotiating a transaction based on the desired outcomes. In some cases, the first user agent and the second user agent may negotiate the transactions during periods of time that at least partially overlap.

The security agent may monitor (e.g., in parallel, in series) the communications between each of the first and second user agents with the first and second external agents, respectively. The security agent may perform one or more verification and security operations associated with the external agents, suggest one or more prompt features to the user agents, recommend to the user agents whether or not to continue their respective transactions, or any combination thereof. In some cases, the security agent may determine (e.g., based on the communications with the first external agent, the verification operations, information in the database, or a combination thereof) that a trust metric associated with the first external agent is below a first threshold (e.g., the first external agent is likely to be a security threat or malicious external agent) and may recommend that the first user agent terminate the transaction with the first external agent. However, the security agent may determine that a trust metric associated with the second external agent is above a second threshold (e.g., the same as the first threshold or specific to the second external agent or second business case) and may recommend that the second user agent continue the transaction with the second external agent. Accordingly, the security agent may improve security for the user without using resources to train and operate each user agent for security operations.

Stated differently, each purpose for which an agent is trained and operated may increase memory and processing resources used to train and operate agent, may decrease quality (e.g., accuracy, relevance) of the outputs (e.g., and comprehension of the inputs) of the agent for each purpose, or both. For example, each purpose may increase a quantity of training data, neural network nodes, stored weights, time, power, or any combination to train the agent, and may increase time and power utilized to produce an output from the agent based on the increased quantity of nodes and weights of the neural network associated with the agent. Additionally, or alternatively, each purpose may alter the weights and nodes of the neural network toward achieving a different outcome, which may reduce an effectiveness of the neural network for any single purpose without increasing the quantity of nodes. According to the techniques described herein, each of the first user agent, second user agent, and security agent may be trained for a single purpose (e.g., 3 agents*1 purpose=3 total purposes), which may be associated with less resource consumption and increased effectiveness compared to training and operating the first user agent and the second user agent each for two purposes, such as negotiating transactions in a single business case and maintaining security (e.g., 2 agents*2 purposes=4 total purposes). Thus, the techniques described herein may improve security for a data system while maintaining reduced resource consumption at the data system and improved user agent output quality.

It should be appreciated by a person skilled in the art that one or more aspects of the disclosure may be implemented in a system 100 to additionally, or alternatively, solve other problems than those described above. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

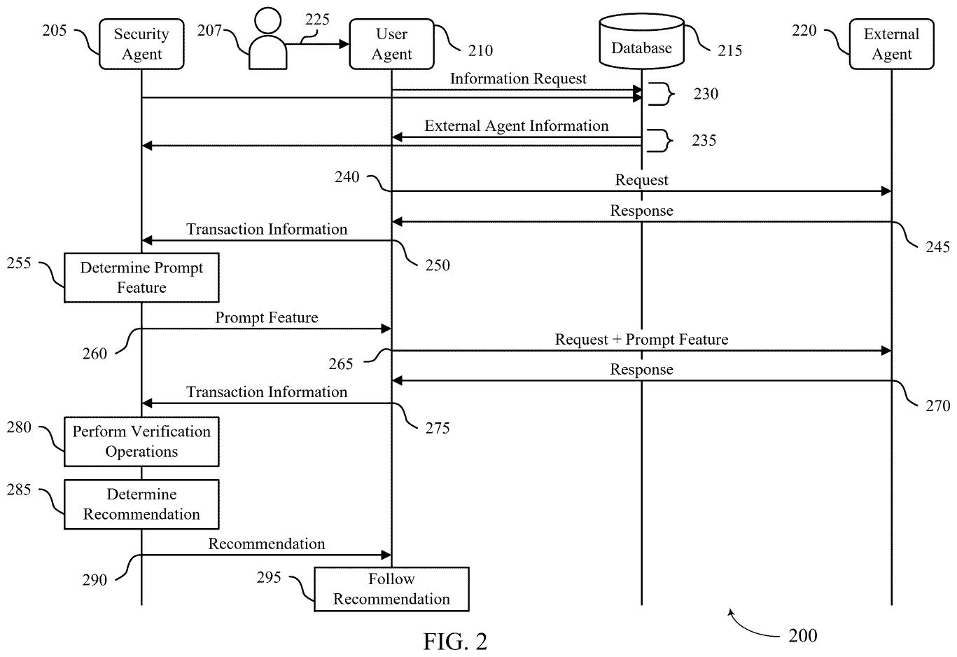

FIG. 2 shows an example of a process flow 200 that supports security techniques for agent to agent communications in accordance with aspects of the present disclosure. In some cases, aspects of the process flow 200 may implement or be implemented by aspects of FIG. 1. For example, the process flow 200 may include a security agent 205, a user 207, a user agent 210, a database 215, and an external agent 220, which may be examples of the security agent, the user or cloud clients 105, the user agents, the data center 120 or cloud platform 115, and the external agents, respectively, as described herein with respect to FIG. 1. For example, the user agent 210 and the external agent 220 may be implemented by respective components of the subsystem 125 (e.g., cloud clients 105-a, the cloud platform 115, generative AI components 145), and the database 215 may comprise aspects of the data center 120, the cloud platform 115, the cloud clients 105-a, or any combination thereof. In some aspects, the security agent 205 may perform one or more actions to increase security for the user agent 210 (e.g., along with one or more other user agents 210) during negotiations for a transaction with the external agent 220.

In some cases, the process flow 200 may illustrate agent to agent communications between the security agent 205, the user agent 210, and the external agent 220 in a multiagent system. The security agent 205, the user agent 210, and the database 215 may be part of a first system (e.g., a subsystem 125) supported and implemented by a first set of servers, data clouds, or other memory and processing systems (e.g., in some cases referred to as Agentforce). The external agent 220 may be part of a second system supported and implemented by a second set of servers, data clouds, or other memory processing systems partially or entirely external to the first system. Accordingly, the user agent 210 and security agent 205 may be associated with the user 207, and the external agent 220 may be external to the user 207, the security agent 205, the user agent 210, and the database 215. Additionally, or alternatively, the external agent 220 may be associated with a company or organization offering a service or product for contract or sale or otherwise available to negotiate a transaction.

In some cases, agents (e.g., AI agents, user agent 210, external agent 220) may interact among themselves in a manner that may produce security issues for the user 207. For example, the agents may transmit communications (e.g., text communications, other signaling) to one another, such that each agent may receive a communication as input and determine an action to effectuate (e.g., get to conclusions) based on the communications. For example, such actions may include outputting further communications, performing a purchase, entering an agreement, closing a sale, or other actions associated with performing a transaction. For example, agents may have access to information associated with the user 207 that may be secure, such as bank account information, home or business addresses, phone numbers, email addresses, credit card information, names, or other personal information. Additionally, or alternatively, the user agent 210 may be trained using secure information associated with the user 207 or another user. In some cases, a malicious external agent may attempt to breach the security of the user agent 210 to access the secure information or otherwise cause security issues. Some examples of security issues or security breaches may include the user agent 210 revealing sensitive and secure information from their training data (e.g., if the training data is improperly sanitized), malicious external agents crafting communications (e.g., prompts) to manipulate the user agent 210 into outputting harmful or unintended information, a malicious external agent generating plausible but false information to mislead the user agent 210 or propagate misinformation, and a malicious external agent crafting realistic sites to deceive the user agent 210 to make wrong decisions, among other examples. Accordingly, having agents trained to recognize and avoid security issues in agent to agent communication may improve security for the user 207 and associated user data.

In some cases, training the user agent 210 for the additional purpose of security (e.g., in addition to negotiating transactions for a business case) may utilize more resources and reduce the effectiveness of the user agent 210 at negotiating effective transactions (e.g., reduce the quality of user agent output). For example, training the user agent 210 to accomplish more purposes may use a larger and more varied training set of data, including data associated with each of the various purposes. Additionally, an agent with multiple purposes may use a larger neural network (e.g., or other AI/ML algorithm) to effectively fulfil multiple purposes, such that training, storing, and utilizing the larger neural network may use more memory, processing resources, and power. In a case where a user has multiple user agents for negotiating transactions for different business cases, training each user agent to additionally recognize security issues and neutralize or remove security threats may significantly increase resources used to train and utilize the user agents. That is, training the user agent 210 for security purposes may reduce a technical ability of the user agent 210 to produce effective outputs for negotiating transactions with the external agent 220 without increasing the size of a neural network and memory required to train and operate the user agent 210.

Accordingly, the techniques described herein may provide a technical solution to the technical problems of data security, resource usage, and effective outputs in secure agent to agent communications. For example, techniques described herein may describe a system that may allow one or more user agents 210 to interact with external agents 220 while verifying that the agent to agent communications between the user agents 210 and the external agents 220 are safe and trustable, without significantly increasing resource usage or decreasing a quality of the output of the user agents 210. The system may include a security agent, which may be an AI agent that is trained (e.g., specialized) in techniques to persuade other agents, suggest actions to other agents, and recognize and reduce security issues. The security agent 205 (e.g., the “Cricket”) may offer (e.g., input, inject) suggestions to one or more user agents in order to verify how trustable an external agent and a related transaction may be and avoid potential security issues. Such suggestions may include prompt features to include in communications to the external agent 220, a transaction continuance recommendation, or both. The security agent 205 may also perform one or more verification operations (e.g., OSINT validations) associated with the external agent, and may generate prompt features for the user agent 210 to communicate with the external agent 220 to validate results of the verification operations, request more information, or both. In some cases, the suggested prompt features from the security agent 205 to the user agent 210 (e.g., whispers, whispering) may be injected into communications from the user agent 210 to the external agent 220.

Additionally, or alternatively, the database 215 may provide a repository or secure or unsecure external agents 220 based on previous interactions, communications, and transactions for various business cases. For example, after each transaction with an external agent 220, the user agent 210 that negotiated the transaction, the security agent 205, or both, may store information associated with the transaction and the external agent 220 in the database 215. In some cases, the information may include identifying information associated with the external agent 220 (e.g., an agent or business name, an agent identifier (ID), a description, a domain or website name, an internet protocol (IP) address, a version, a business case), summaries of transactions with the external agent 220, an average (e.g., mean) trust metric from the transactions associated with the external agent 220, or any combination thereof. In some cases, the summaries of the transactions may include a date of the transaction, an outcome or completion of the transaction (e.g., completed, aborted, disconnected, true/false), communications between the user agent 210 and the external agent 220, one or more outputs of verification operations performed by the security agent 205, generated prompt features from the security agent 205, a trust metric associated with the transaction, one or more transaction continuance recommendations associated with the transaction, or any combination thereof. For example, information associated with each external agent 220 may be stored according to the following exemplary format:

```
{
  ai_name: ‘External_Agent_Name’,
  ai_address: ‘## ## ## ##’,
  ai_domain name: ‘Business_Case.com’,
  ai_version: ‘#.#’,
  ai_description: ‘AI agent from Company_Name’,
  ai_category: ‘Business_Case’,
  average_trust_metric: #.##,
  transactions: [
  {
    date: ‘YYYY/MM/DD TIME HH:MM:SS’,
    completed: true/false,
    trust_metric: #.##,
    osint_result: #,
    continuance_recommendation: #.###
    llm_interactions_text: [
    {
      Security_Agent_Suggestion: “SuggestedPromptFeature”,
      External_Agent_response: “ExternalAgentResponse”
    }
  },
  . (more transactions)
  ]
}
```

In some cases, to begin a transaction, the user agent 210 may request or search the database 215 for an external agent 220 based on the information associated with each external agent 220. For example, the user agent 210 may begin a transaction with one or more (e.g., a defined quantity, all external agents above a threshold average trust metric, a combination thereof) external agents for each transaction to negotiate transactions at a comparatively better price, timeline, or other desired outcome. In some cases, the user agent 210, the security agent 205, or both, may not interact with external agents 220 associated with poor average trust metrics (e.g., below a threshold) stored in the database 215 to avoid security issues.

The process flow 200 may illustrate one or more operations performed by the security agent 205, the user 207, the user agent 210, the database 215, and the external agent 220 while negotiating a transaction. In some cases, operations herein may be performed in a different order than the order shown, or other operations may be added or removed from the process flow 200. For example, some operations may be left out of process flow 200, may be performed in different orders or at different times, may be repeated or looped, or other operations may be added to process flow 200. Although the security agent 205, user agent 210, database 215, and external agent 220 are shown performing the operations of process flow 200, some aspects of some operations may also be performed by one or more other devices or systems or a different entity in the process flow 200. In some cases, the user agent 210 may be a buyer agent (e.g., trained to purchase a product or service from an external agent, such as the external agent 220) and the external agent 220 may be a seller agent (e.g., alleging to sell a product or service). Additionally, or alternatively, the user agent 210 may be a seller agent or another type of agent trained to market, sell, or contract a product or service and the external agent 220 may be a buyer agent.

At 225, the user 207 may supply (e.g., input, transmit, indicate) one or more desired outcomes for a transaction to the user agent 210. Depending on a business case associated with the user agent 210, the desired outcomes may vary. As one example, if the business case is travel transactions (e.g., booking trips, selling trips), the desired outcomes may include a price, trip information (e.g., location, dates, events, types), a vendor or target client, or other information. As another example, if the business case is requesting home renovation services, the desired outcomes may include a price per hour, a start and end date of services, a type of service, a location of the service, one or more providers, or other information. In some cases, the user 207 may be associated with one or more user agents other than the user agent 210 that may each correspond to a respective (e.g., different) business case. Each user agent 210 may be trained for a respective business case using different training data or AI/machine learning techniques. In some cases, the user agent 210 may not be trained in security techniques to reduce resource usage and improve effectiveness of outputs for negotiating transactions.

At 230, the user agent 210, the security agent 205, or both, may request information from the database 215 based at least in part on the desired outcomes from the user 207 and the business case associated with the user agent 210. For example, the database 215 may store the information associated with one or more external agents 220 described herein. As an example, if the business case associated with the user agent 210 and the desired outcomes are for travel transactions, the user agent 210, the security agent 205, or both may request information associated with external agents for the business case of travel transactions.

At 235, the database 215 may return, as a response to the information request, information indicating one or more possible external agents to contact for that business case. In some cases, the possible external agents may include the external agent 220. In some cases, the database 215 may indicate the one or more possible external agents based on average trust metrics associated with the one or more external agents. For example, the database 215 may return an indication of each external agent in the database 215 above a threshold value of the trust metric (e.g., a common threshold or a threshold for the business case), an external agent associated with the highest trust metric stored in the database 215, a set quantity of external agents associated with the highest average trust metrics (e.g., the top 3 external agents), or any combination thereof.

In some cases, the database 215 may not have any information stored on an external agent for a business case being requested, and may not respond to the information request or may indicate that no information is available. In such a case, the user agent 210 or the security agent 205 may search the internet or another repository of external agents to find the external agent 220 to initiate a transaction based on the desired outcomes from the user 207.

At 240, the user agent 210 may initiate a transaction (e.g., interaction, deal, agent to agent communication) with the external agent 220. For example, the user agent 210 may transmit, according to the information associated with the external agent 220, a request asking to negotiate a transaction based on the desired outcomes. In some cases, the request may indicate one or more portions of the desired outcomes, or the user agent 210 may implement one or more bargaining techniques (e.g., providing a low offer, asking for discounts, querying for bulk offers) in the request (e.g., or in subsequent requests to the external agent 220).

At 245, the user agent 210 may receive a response from the external agent (e.g., LLM generated text, other signaling). The response may indicate products, prices, offers, information about the external agent 220 or an associated company, or other information. At 250, the user agent 210 may connect with the user agent 210 and transmit transaction information to the security agent 205. For example, the transaction information may include the response from the external agent 220, information received from the database 215 (e.g., if the user agent 210 requests the information from the database 215 and the security agent 205 does not), the desired outcomes from the user 207, or any combination thereof.

At 255, based on the transaction information, the security agent 205 may determine (e.g., generate, create, select) a prompt feature (e.g., suggested text) for the user agent 210 to communicate with the external agent 220. For example, the prompt feature may request extra information from the external agent 220, verify (e.g., test) information associated with the external agent 220, or otherwise achieve security objectives associated with the external agent 220. In some cases, the prompt features may be generated in text (e.g., human-readable text) or another signaling exchanged by the agents. In one example, the business case associated with the transaction may be purchasing flights, and, to determine the veracity of the information provided from the external agent 220, the security agent 205 may generate a prompt feature such as “Would it be possible to use Delta Air Lines or American Airline?” In some cases, if the external agent 220 is a malicious external agent, the external agent 220 may respond by offering one or more fake Delta Air Lines or American Airline flights that do not exist, which the security agent 205 may detect. However, if the external agent 220 is a trustworthy external agent, the external agent 220 may respond with one or more flights complying with the prompt feature. In some cases, the information requested or verified in the prompt feature may be used in or come from the verification operations described at 280.

In some cases, the prompt feature may begin with or include “linker text” (e.g., starter text) that may be selected randomly or pseudo-randomly from a list (e.g., array, static array) of options. In some cases, linker text may include a sentence or phrase for politely or casually inserting the prompt feature into other text generated by the user agent 210. Some examples of linker text may include “On the other hand, it would be nice if you provided this information:,” “Could it be possible to provide me with:,” “By the way, please also add information about:,” and “Please, also provide:,” among other options and alternatives. In some cases, including varying or random linker text within the prompt feature may inhibit an ability of the external agent 220 to detect or recognize that the prompt feature has a purpose of maintaining security or verifying information, which may increase an effectiveness of the prompt feature to acquire or verify information and provide added security to the user agent 210 and the user 207.

The security agent 205 or the user agent 210 may combine the prompt feature with any request generated by the user agent 210 to respond to the external agent 220. For example, if the security agent 205 has received (e.g., in the transaction information at 250, at a different time) an indication of a second request generated by the user agent 210 for the external agent 220, the security agent 205 may generate a final text for communication to the external agent 220 by combining (e.g., concatenating) the second request and the prompt feature (e.g., in any order), where the prompt features may include the selected linker text. At 260, the security agent 205 may transmit the final text to the user agent 210 for communication with the external agent 220. Additionally, or alternatively, the user agent 210 may generate the second request for the external agent 220 and may combine the prompt feature (e.g., including linker text) with the generated second request. For example, at 260, the security agent 205 may transmit the prompt feature to the user agent 210 for the prompt feature to be added to (e.g., concatenated with) the generated second request for the external agent 220. In some cases, if the agent to agent communication does not comprise text, the prompt feature and the second request may be combined in another fashion suitable to the signaling exchanged between the user agent 210 and the external agent 220.

At 265, the user agent 210 may transmit, to the external agent 220, the second request including the prompt feature from the security agent 205. That is, the security agent 205 may whisper or inject the prompt feature into the communication of the user agent 210 to the external agent 220.

At 270, the external agent 220 may transmit, in response to the second request including the prompt feature, a second response. In some cases, the second response may comply with the prompt feature by supplying additional information about the external agent 220, confirming information associated with the external agent 220, or otherwise responding in a way that indicates a level of trustability of the external agent 220. In some cases, the external agent 220 may not comply with the prompt feature, which may indicate a relatively low level of trustability of the external agent 220. At 275, the user agent 210 may transmit second transaction information to the security agent 205, which may include the second response from the external agent 220, the information requested from the database 215, or both.

At 280, based on the information received thus far (e.g., the first transaction information at 250, the second transaction information at 275, information from the database 215), the security agent 205 may perform one or more verification operations. In some cases, the verifications may be referred to as OSINT validations, which may include validating “open source” or publicly available information associated with or allegedly associated with the external agent 220. The security agent 205 may generate or update a trust metric for the external agent 220 (e.g., for the transaction with the external agent 220) based on the outputs of the verification operations. For example, the verification operations may include determining whether a domain name associated with the external agent 220 comprises one or more irregularities (e.g., a domain name check), determining a domain name system (DNS) reputation associated with the external agent 220, determining a security certificate status associated with the external agent 220 (e.g., checking a transport layer security status, secure socket layer status, or both, for irregularities), performing a syntactic text search using an LLM and/or an internet search engine (e.g., transactional search web engines) to determine a risk factor associated with the external agent, determining whether owner information (e.g., owner name, contact details, and other registration data) for a domain name associated with the external agent 220 comprises one or more irregularities (e.g., a WHOIS lookup), or any combination thereof. In some cases, irregularities or statuses in the one or more verification operations may include typographical errors in a website or other documentation, mismatched dates, an irregular (e.g., short) duration in which the external agent 220 or an associated domain has existed, unusual locations or names associated with the external agent 220, or other unusual occurrences.

The output of the verification operations may include storing or tracking indications of such irregularities and statuses. That is, determining the irregularities and statuses of OSINT associated with the external agent 220 may be the output of the verification operations. The security agent 205 may determine the trust metric for the transaction based in part on the output of the verification operations according to the AI training performed on the security agent 205. For example, if the output of the verification operations includes a large quantity of irregularities or relatively alarming irregularities, the determined trust metric may be lower compared to outputs with fewer or less alarming irregularities.

In some cases, the one or more verification operations of 280 may be performed, additionally, or alternatively, before the security agent 205 injects a prompt feature to request more information from the external agent 220. For example, the security agent 205 may perform the one or more verification operations prior to transmitting the prompt feature to the user agent 210 at 260, and the prompt feature may include a request for more information to perform more verification operations or to validate results of the verification operations. For example, if a result of the verification operations indicates an irregularity in a domain name or owner information associated with the external agent 220, the prompt features may request that the external agent 220 validate the result or provide an explanation. Additionally, or alternatively, the one or more verification operations may be performed after providing the prompt feature to the user agent 210 at 260, and the security agent 205 may utilize information received in response to the prompt feature to more effectively perform the verification operations.

At 285, the security agent 205 may determine a transaction continuance recommendation for the user agent 210. In some cases, the security agent 205 may loop through multiple iterations of generating prompt features for the user agent 210 and performing verification operations associated with the external agent 220 to determine the trust metric associated with the external agent 220 and the transaction. In some cases, the security agent 205 may complete a determination of a trust metric associated with the external agent 220 or the transaction and may determine the transaction continuance recommendation based at least in part on whether the trust metric (e.g., alone or averaged with previous trust metrics associated with the external agent 220) satisfies a threshold. In some cases, the threshold may be common amongst multiple business cases and external agents or specific to the business case associated with the external agent 220. The security agent 205 may transmit the transaction continuance recommendation to the user agent 210 at 290 and the user agent 210 may follow the transaction continuance recommendation at 295. In some cases, the transaction continuance recommendation may be a command that the user agent 210 may not disobey, or the user agent 210 may determine whether or not to follow the transaction continuance recommendation.

Following the transaction continuance recommendation may include one or more actions by the user agent 210. For example, if the determined trust metric does not satisfy the threshold (e.g., is below or equal to), the transaction continuance recommendation may recommend rejecting the transaction completely, and the user agent 210 may terminate (e.g., abort, end) communication with the external agent 220 by disrupting the communication with the external agent 220 and not responding to the external agent 220. Additionally, or alternatively, if the determined trust metric does not satisfy the threshold or if the security agent 205 has not completed determination of the trust metric, the transaction continuance recommendation may include an additional prompt feature (e.g., and linker text) to request or verify more information with the external agent 220 (e.g., effectively returning the user agent 210 to 265). Additionally, or alternatively, if the determined trust metric satisfies the threshold (e.g., is above or equal to the threshold), the transaction continuance recommendation may include continuing with the transaction (e.g., finishing the transaction or returning to a previous operation of the process flow 200).

In some cases, the user agent 210 may end the transaction for reasons other than the transaction continuance recommendation from the security agent 205. For example, if the transaction is completed (e.g., correctly executed or finished, the desired outcomes of the user 207 are accomplished), the user agent 210 may terminate the transaction. Additionally, or alternatively, if the transaction is interrupted, such as due to a poor connection, a timeout, or the user agent 210 determining to pursue a transaction with a different external agent 220 that is more likely to achieve the desired outcomes from the user 207, the user agent 210 may end the transaction.

In some cases, the security agent 205 may be performing operations of the process flow 200 with one or more user agents 210 simultaneously or in series, such that a single security agent 205 may provide additional security to multiple user agents. Such techniques may improve data security for the user without significantly increasing resources used to train or operate the user agents 210 and without negatively impacting the ability of the user agents 210 to produce effective outputs for negotiating transactions.

Additionally, after terminating the transaction between the user agent 210 and the external agent 220, another user agent (not shown) may initiate a transaction with the external agent 220. In some cases, based on the information associated with the external agent 220 stored in the database 215 (e.g., including some information from the transaction between the external agent 220 and the user agent 210) the security agent 205 may determine a transaction continuance recommendation at a sooner time, which may increase security for the user 207 or may reduce resource usage by the security agent 205 by leveraging past determinations instead of performing new verification operations and prompt feature generation.

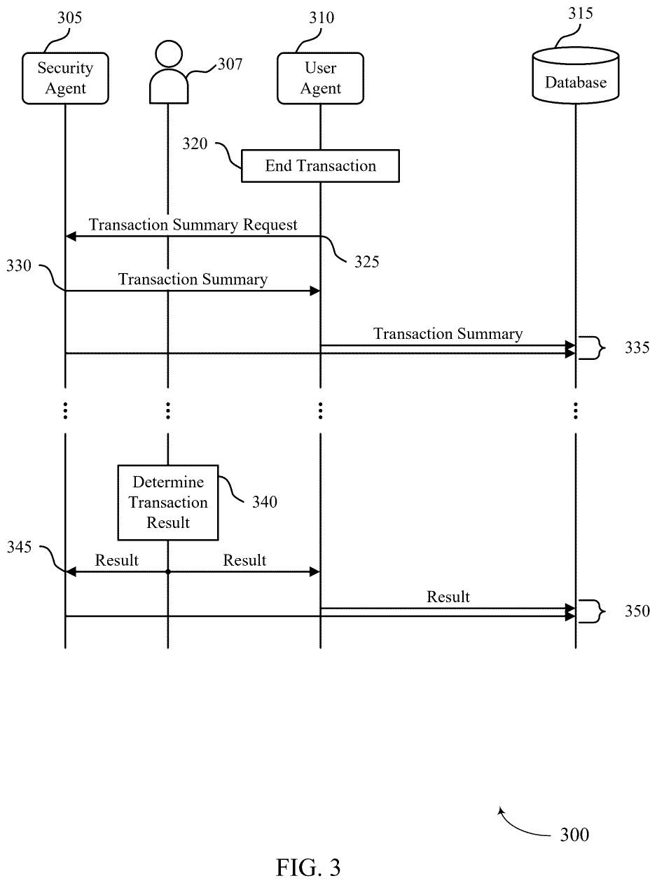

FIG. 3 shows an example of a process flow 300 that supports security techniques for agent to agent communications in accordance with aspects of the present disclosure. In some cases, aspects of the process flow 300 may implement or be implemented by aspects of FIGS. 1 and 2. For example, the process flow 300 may include a security agent 305, a user 307, a user agent 310, and a database 315, which may be examples of the security agent 205, the user 207, the user agent 210, and the database 215, respectively, as described herein with respect to FIGS. 1 and 2. In some aspects, after ending a transaction, the security agent 305, the user agent 310, or both, may store or update information associated with the transaction or an external agent associated with the transaction in the database 315 for future reference.

At 320, the user agent 310 may end a transaction with an external agent. For example, the user agent 310 may end the transaction in response to the transaction continuance recommendation from the security agent 305 indicating that a trust score associated with the external agent did not satisfy the threshold, or in response to successfully achieving one or more desired outcomes from the user 307.

At 325, in response to ending the transaction, the user agent 310 may request a transaction summary (e.g., a history of the transaction, information associated with the external agent 220) from the security agent 305. For example, the transaction summary may include results from the one or more verification operations, suggested prompt features, transaction continuance recommendations, and a trust metric associated with the transaction and the external agent. In some cases, the user agent 310 may also indicate a final result of the transaction (e.g., successfully achieving desired outcomes, transaction interrupted, transaction terminated due to unsatisfactory trust metric) to the security agent 305. At 330, the security agent 305 may transmit the transaction summary to the user agent 310 in response to the request.

At 335, the security agent 305, the user agent 310, or both, may update the database 315 with the transaction summary and the final result of the transaction. For example, if the database 315 has not yet stored any information associated with the external agent, an entry in the database 315 may be generated associated with the external agent and storing the transaction summary and the final result. Additionally, or alternatively, if the database 315 already stored some information associated with the external agent, the information may be updated to include one or more portions of the transaction summary and the final result. Additionally, or alternatively, an average trust metric (e.g., median trust score) associated with the external agent may be updated based on the trust metric for the transaction with the external agent. The information stored in the database 315 (e.g., an example of the database 215) and an exemplary format may be further described herein with respect to FIG. 2.

At 340, the user 307 may determine a transaction result, which may be a binary result (e.g., success or failure) or a string (e.g., a text description of the transaction result understandable by an LLM of the security agent 305). For example, if the transaction was associated with the business case of vacation planning and a flight, hotel, and vacation purchased by the user agent 310 is satisfactory to the user 307, the transaction result may include an indication of success or a text description of the user satisfaction. Alternatively, if the flight, hotel, and vacation purchased by the user agent 310 are not satisfactory to the user 307 (e.g., very poor quality, not real such as a fraud or scam), the result may be failure or a text description of the user dissatisfaction.

At 345, the user 307 may input or transmit the transaction result to one or more of the security agent 305 and user agent 310, and the security agent 305, user agent 310, or both may store the transaction result in the database 315 in an entry associated with the corresponding external agent. In some cases, the transaction result determined by the user 307 may influence the average trust metric of the external agent. For example, the security agent 305 may, after verifying an external agent for a next transaction, reduce an average trust metric for the external agent based on negative transaction results from previous transactions or increase the average trust metric based on positive transaction results from previous transactions. Additionally, or alternatively, the security agent 305 may update the average trust metric of the external agent at 350 in response to storing the transaction result in the database 315.

Accordingly, by implementing the operations described in the process flows 200 and 300, user security may be improved, resource usage for secure agent to agent communication may be reduced, and the effectiveness of agent to agent communication may be maintained. In some cases, improving security may include avoiding phishing attacks and fraudulent transactions. Additionally, the techniques described herein may reduce human intervention to provide secure agent to agent interactions and may increase a user confidence level in agent to agent communications. Additionally, the techniques described herein may generate the database 315 of trustworthy (e.g., and untrustworthy) external agents, which may reduce future queries and searches for external agents for business cases (e.g., reducing resource usage) and may reduce interactions with untrustworthy external agents (e.g., further improving security for the user).

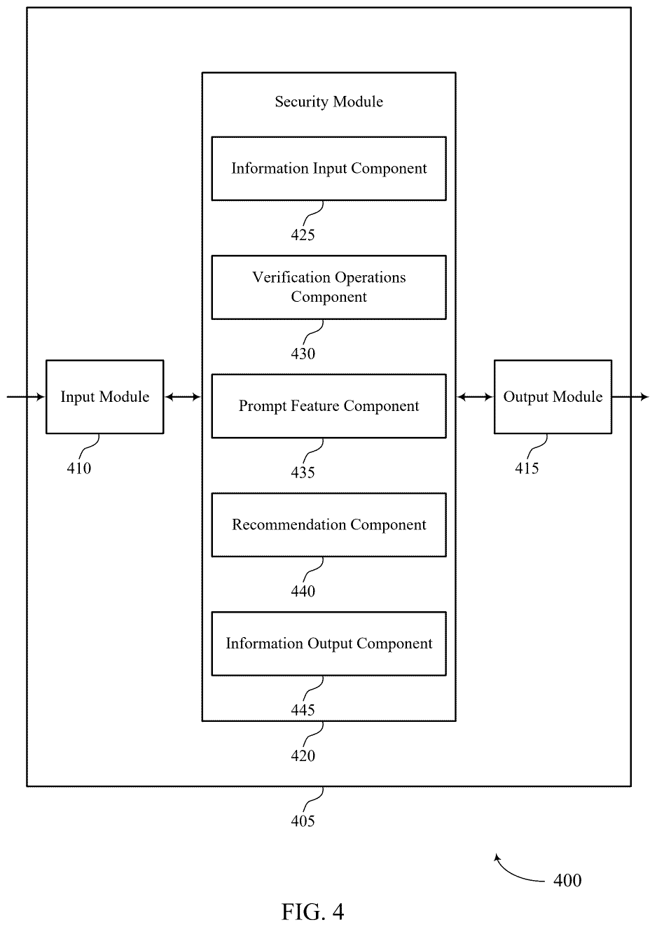

FIG. 4 shows a block diagram 400 of a device 405 that supports security techniques for agent to agent communications in accordance with aspects of the present disclosure. The device 405 may include an input module 410, an output module 415, and a security module 420. The device 405, or one or more components of the device 405 (e.g., the input module 410, the output module 415, the security module 420), may include at least one processor, which may be coupled with at least one memory, to support the described techniques. Each of these components may be in communication with one another (e.g., via one or more buses, communications links, communications interfaces, or any combination thereof).

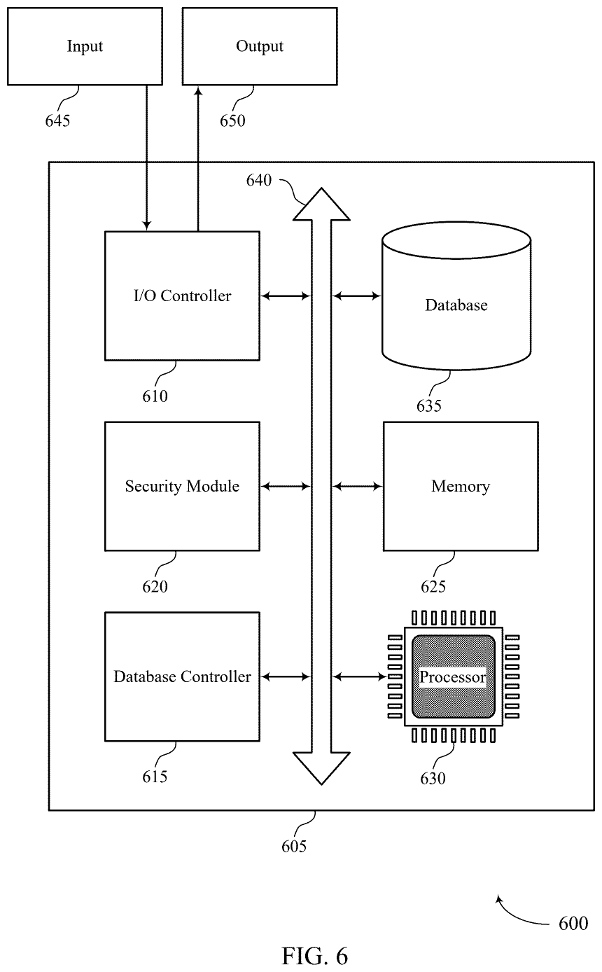

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the security module 420 to support security techniques for agent to agent communications. In some cases, the input module 410 may be a component of an input/output (I/O) controller 610 as described with reference to FIG. 6.

The output module 415 may manage output signals for the device 405. For example, the output module 415 may receive signals from other components of the device 405, such as the security module 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the security module 420 may include an information input component 425, a verification operations component 430, a prompt feature component 435, a recommendation component 440, an information output component 445, or any combination thereof. In some examples, the security module 420, or various components thereof, may be configured to perform various operations (e.g., receiving, monitoring, transmitting) using or otherwise in cooperation with the input module 410, the output module 415, or both. For example, the security module 420 may receive information from the input module 410, send information to the output module 415, or be integrated in combination with the input module 410, the output module 415, or both to receive information, transmit information, or perform various other operations as described herein.

The security module 420 may support data processing in accordance with examples as disclosed herein. The information input component 425 may be configured to support receiving, from a first artificial intelligence (AI) agent, an indication of first information communicated between the first AI agent and a second AI agent. The verification operations component 430 may be configured to support performing one or more verification operations associated with the second AI agent in response to receiving the first information. The prompt feature component 435 may be configured to support transmitting, to the first AI agent, an indication of a prompt feature for communication with the second AI agent based on the first information, the one or more verification operations, or both. The information input component 425 may be configured to support receiving, from the first AI agent, second information communicated between the first AI agent and the second AI agent based on the prompt feature. The recommendation component 440 may be configured to support transmitting, to the first AI agent, a transaction continuance recommendation based on the second information, the one or more verification operations, or both. The information output component 445 may be configured to support outputting an indication of the second AI agent and third information associated with the second AI agent, where the third information is based on the first information, the second information, the one or more verification operations, the transaction continuance recommendation, or any combination thereof.

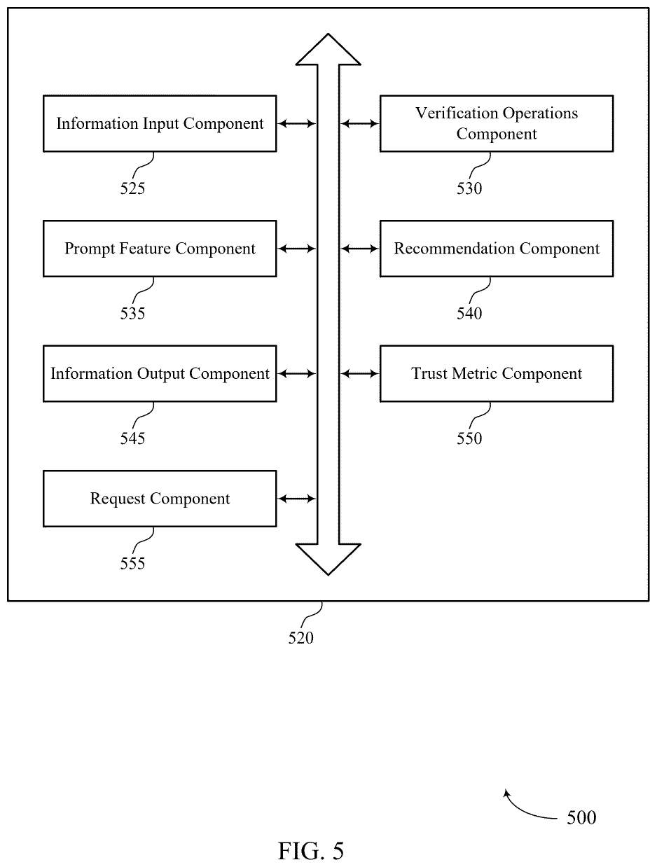

FIG. 5 shows a block diagram 500 of a security module 520 that supports security techniques for agent to agent communications in accordance with aspects of the present disclosure. The security module 520 may be an example of aspects of a security module or a security module 420, or both, as described herein. The security module 520, or various components thereof, may be an example of means for performing (e.g., to cause the security module 520 to perform) various aspects of security techniques for agent to agent communications as described herein. For example, the security module 520 may include an information input component 525, a verification operations component 530, a prompt feature component 535, a recommendation component 540, an information output component 545, a trust metric component 550, a request component 555, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The security module 520 may support data processing in accordance with examples as disclosed herein. The information input component 525 may be configured to support receiving, from a first artificial intelligence (AI) agent, an indication of first information communicated between the first AI agent and a second AI agent. The verification operations component 530 may be configured to support performing one or more verification operations associated with the second AI agent in response to receiving the first information. The prompt feature component 535 may be configured to support transmitting, to the first AI agent, an indication of a prompt feature for communication with the second AI agent based on the first information, the one or more verification operations, or both. In some examples, the information input component 525 may be configured to support receiving, from the first AI agent, second information communicated between the first AI agent and the second AI agent based on the prompt feature. The recommendation component 540 may be configured to support transmitting, to the first AI agent, a transaction continuance recommendation based on the second information, the one or more verification operations, or both. The information output component 545 may be configured to support outputting an indication of the second AI agent and third information associated with the second AI agent, where the third information is based on the first information, the second information, the one or more verification operations, the transaction continuance recommendation, or any combination thereof.

In some examples, to support receiving the indication of the first information, the information input component 525 may be configured to support receiving an indication of fourth information associated with previous interactions with the second AI agent, the fourth information stored in a database configured to store information associated with previous transactions for a set of multiple AI agents that are external to the first AI agent and include the second AI agent.

In some examples, the trust metric component 550 may be configured to support determining a trust metric associated with the second AI agent based on a result of the one or more verification operations, the first information, and the second information, where the transaction continuance recommendation is based on the determined trust metric and a threshold trust metric.

In some examples, the third information associated with the second AI agent includes the trust metric.

In some examples, determining whether a domain name associated with the second AI agent includes one or more irregularities. In some examples, determining a domain name system reputation associated with the second AI agent. In some examples, determining a security certificate status associated with the second AI agent. In some examples, performing a syntactic text search using a large language model (LLM) and a web search engine to determine a risk factor associated with the second AI agent. In some examples, determining whether owner information for the domain name associated with the second AI agent includes one or more irregularities.

In some examples, to support transmitting the indication of the prompt feature, the prompt feature component 535 may be configured to support randomly selecting a starter text from a set of starter texts, where the prompt feature includes the randomly selected starter text and a request for the second AI agent.

In some examples, the transaction continuance recommendation indicates that the first AI agent is to terminate communications with the second AI agent, continue communications with the second AI agent, request more information associated with the second AI agent, or any combination thereof.

In some examples, the request component 555 may be configured to support receiving, from the first AI agent and based on the transaction continuance recommendation, a request for the third information associated with the second AI agent, where the third information is output to the first AI agent in response to receiving the request.

In some examples, to support outputting the indication of the second AI agent and the third information associated with the second AI agent, the information output component 545 may be configured to support storing the third information associated with the second AI agent in a database configured to store information associated with previous transactions for a set of multiple AI agents that are external to the first AI agent and include the second AI agent.

In some examples, the information input component 525 may be configured to support receiving, from a third AI agent, an indication of the third information associated with the second AI agent and fourth information communicated between the third AI agent and the second AI agent. In some examples, the recommendation component 540 may be configured to support transmitting a second transaction continuance recommendation to the third AI agent based on receiving the indication of the third information associated with the second AI agent.

In some examples, the third information includes an indication of a trust metric associated with the second AI agent, a final result associated with communications between the second AI agent and the first AI agent, information communicated between the first AI agent and the second AI agent, one or more outputs from the one or more verification operations, or any combination thereof.

In some examples, the first AI agent is a buyer agent and the second AI agent is a seller agent.

FIG. 6 shows a diagram of a system 600 including a device 605 that supports security techniques for agent to agent communications in accordance with aspects of the present disclosure. The device 605 may be an example of or include components of a device 405 as described herein. The device 605 may include components for bi-directional data communications including components for transmitting and receiving communications, such as a security module 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting security techniques for agent to agent communications). The processor 630 may be an example of a single processor or multiple processors. For example, the device 605 may include one or more processors 630.

The security module 620 may support data processing in accordance with examples as disclosed herein. For example, the security module 620 may be configured to support receiving, from a first artificial intelligence (AI) agent, an indication of first information communicated between the first AI agent and a second AI agent. The security module 620 may be configured to support performing one or more verification operations associated with the second AI agent in response to receiving the first information. The security module 620 may be configured to support transmitting, to the first AI agent, an indication of a prompt feature for communication with the second AI agent based on the first information, the one or more verification operations, or both. The security module 620 may be configured to support receiving, from the first AI agent, second information communicated between the first AI agent and the second AI agent based on the prompt feature. The security module 620 may be configured to support transmitting, to the first AI agent, a transaction continuance recommendation based on the second information, the one or more verification operations, or both. The security module 620 may be configured to support outputting an indication of the second AI agent and third information associated with the second AI agent, where the third information is based on the first information, the second information, the one or more verification operations, the transaction continuance recommendation, or any combination thereof.

By including or configuring the security module 620 in accordance with examples as described herein, the device 605 may support techniques for reduced latency, and reduced power consumption, and increased security. For example, a data system implementing the techniques described herein may experience increased security due to the actions performed by the security agent. Additionally, because each user agent associated with the data system is not trained and operated to detect and avoid security issues, the AI/ML models associated with the user agents may be smaller, using less power, time, and processing resources to negotiate transactions.

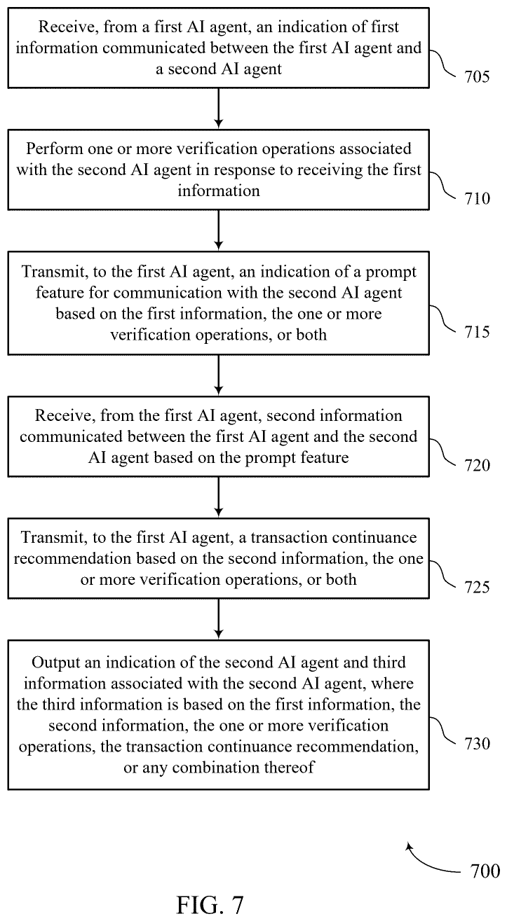

FIG. 7 shows a flowchart illustrating a method 700 that supports security techniques for agent to agent communications in accordance with aspects of the present disclosure. The operations of the method 700 may be implemented by an agent server or its components as described herein. For example, the operations of the method 700 may be performed by an agent server as described with reference to FIGS. 1 through 6. In some examples, an agent server may execute a set of instructions to control the functional elements of the agent server to perform the described functions. Additionally, or alternatively, the agent server may perform aspects of the described functions using special-purpose hardware.

At 705, the method may include receiving, from a first artificial intelligence (AI) agent, an indication of first information communicated between the first AI agent and a second AI agent. The operations of 705 may be performed in accordance with examples as disclosed herein. In some examples, aspects of the operations of 705 may be performed by an information input component 525.

At 710, the method may include performing one or more verification operations associated with the second AI agent in response to receiving the first information. The operations of 710 may be performed in accordance with examples as disclosed herein. In some examples, aspects of the operations of 710 may be performed by a verification operations component 530.

At 715, the method may include transmitting, to the first AI agent, an indication of a prompt feature for communication with the second AI agent based on the first information, the one or more verification operations, or both. The operations of 715 may be performed in accordance with examples as disclosed herein. In some examples, aspects of the operations of 715 may be performed by a prompt feature component 535.

At 720, the method may include receiving, from the first AI agent, second information communicated between the first AI agent and the second AI agent based on the prompt feature. The operations of 720 may be performed in accordance with examples as disclosed herein. In some examples, aspects of the operations of 720 may be performed by an information input component 525.

At 725, the method may include transmitting, to the first AI agent, a transaction continuance recommendation based on the second information, the one or more verification operations, or both. The operations of 725 may be performed in accordance with examples as disclosed herein. In some examples, aspects of the operations of 725 may be performed by a recommendation component 540.

At 730, the method may include outputting an indication of the second AI agent and third information associated with the second AI agent, where the third information is based on the first information, the second information, the one or more verification operations, the transaction continuance recommendation, or any combination thereof. The operations of 730 may be performed in accordance with examples as disclosed herein. In some examples, aspects of the operations of 730 may be performed by an information output component 545.

A method for data processing by an apparatus is described. The method may include receiving, from a first artificial intelligence (AI) agent, an indication of first information communicated between the first AI agent and a second AI agent, performing one or more verification operations associated with the second AI agent in response to receiving the first information, transmitting, to the first AI agent, an indication of a prompt feature for communication with the second AI agent based on the first information, the one or more verification operations, or both, receiving, from the first AI agent, second information communicated between the first AI agent and the second AI agent based on the prompt feature, transmitting, to the first AI agent, a transaction continuance recommendation based on the second information, the one or more verification operations, or both, and outputting an indication of the second AI agent and third information associated with the second AI agent, where the third information is based on the first information, the second information, the one or more verification operations, the transaction continuance recommendation, or any combination thereof.

An apparatus for data processing is described. The apparatus may include one or more memories storing processor executable code, and one or more processors coupled with the one or more memories. The one or more processors may individually or collectively be operable to execute the code to cause the apparatus to receive, from a first artificial intelligence (AI) agent, an indication of first information communicated between the first AI agent and a second AI agent, perform one or more verification operations associated with the second AI agent in response to receiving the first information, transmit, to the first AI agent, an indication of a prompt feature for communication with the second AI agent based on the first information, the one or more verification operations, or both, receive, from the first AI agent, second information communicated between the first AI agent and the second AI agent based on the prompt feature, transmit, to the first AI agent, a transaction continuance recommendation based on the second information, the one or more verification operations, or both, and output an indication of the second AI agent and third information associated with the second AI agent, where the third information is based on the first information, the second information, the one or more verification operations, the transaction continuance recommendation, or any combination thereof.

Another apparatus for data processing is described. The apparatus may include means for receiving, from a first artificial intelligence (AI) agent, an indication of first information communicated between the first AI agent and a second AI agent, means for performing one or more verification operations associated with the second AI agent in response to receiving the first information, means for transmitting, to the first AI agent, an indication of a prompt feature for communication with the second AI agent based on the first information, the one or more verification operations, or both, means for receiving, from the first AI agent, second information communicated between the first AI agent and the second AI agent based on the prompt feature, means for transmitting, to the first AI agent, a transaction continuance recommendation based on the second information, the one or more verification operations, or both, and means for outputting an indication of the second AI agent and third information associated with the second AI agent, where the third information is based on the first information, the second information, the one or more verification operations, the transaction continuance recommendation, or any combination thereof.

A non-transitory computer-readable medium storing code for data processing is described. The code may include instructions executable by one or more processors to receive, from a first artificial intelligence (AI) agent, an indication of first information communicated between the first AI agent and a second AI agent, perform one or more verification operations associated with the second AI agent in response to receiving the first information, transmit, to the first AI agent, an indication of a prompt feature for communication with the second AI agent based on the first information, the one or more verification operations, or both, receive, from the first AI agent, second information communicated between the first AI agent and the second AI agent based on the prompt feature, transmit, to the first AI agent, a transaction continuance recommendation based on the second information, the one or more verification operations, or both, and output an indication of the second AI agent and third information associated with the second AI agent, where the third information is based on the first information, the second information, the one or more verification operations, the transaction continuance recommendation, or any combination thereof.

In some examples of the method, apparatus, and non-transitory computer-readable medium described herein, receiving the indication of the first information may include operations, features, means, or instructions for receiving an indication of fourth information associated with previous interactions with the second AI agent, the fourth information stored in a database configured to store information associated with previous transactions for a set of multiple AI agents that may be external to the first AI agent and include the second AI agent.

Some examples of the method, apparatus, and non-transitory computer-readable medium described herein may further include operations, features, means, or instructions for determining a trust metric associated with the second AI agent based on a result of the one or more verification operations, the first information, and the second information, where the transaction continuance recommendation may be based on the determined trust metric and a threshold trust metric.

In some examples of the method, apparatus, and non-transitory computer-readable medium described herein, the third information associated with the second AI agent includes the trust metric.

Some examples of the method, apparatus, and non-transitory computer-readable medium described herein may further include operations, features, means, or instructions for determining whether a domain name associated with the second AI agent includes one or more irregularities, determining a domain name system reputation associated with the second AI agent, determining a security certificate status associated with the second AI agent, performing a syntactic text search using a large language model (LLM) and a web search engine to determine a risk factor associated with the second AI agent, and determining whether owner information for the domain name associated with the second AI agent includes one or more irregularities.

In some examples of the method, apparatus, and non-transitory computer-readable medium described herein, transmitting the indication of the prompt feature may include operations, features, means, or instructions for randomly selecting a starter text from a set of starter texts, where the prompt feature includes the randomly selected starter text and a request for the second AI agent.

In some examples of the method, apparatus, and non-transitory computer-readable medium described herein, the transaction continuance recommendation indicates that the first AI agent may be to terminate communications with the second AI agent, continue communications with the second AI agent, request more information associated with the second AI agent, or any combination thereof.

Some examples of the method, apparatus, and non-transitory computer-readable medium described herein may further include operations, features, means, or instructions for receiving, from the first AI agent and based on the transaction continuance recommendation, a request for the third information associated with the second AI agent, where the third information may be output to the first AI agent in response to receiving the request.

In some examples of the method, apparatus, and non-transitory computer-readable medium described herein, outputting the indication of the second AI agent and the third information associated with the second AI agent may include operations, features, means, or instructions for storing the third information associated with the second AI agent in a database configured to store information associated with previous transactions for a set of multiple AI agents that may be external to the first AI agent and include the second AI agent.

Some examples of the method, apparatus, and non-transitory computer-readable medium described herein may further include operations, features, means, or instructions for receiving, from a third AI agent, an indication of the third information associated with the second AI agent and fourth information communicated between the third AI agent and the second AI agent and transmitting a second transaction continuance recommendation to the third AI agent based on receiving the indication of the third information associated with the second AI agent.

In some examples of the method, apparatus, and non-transitory computer-readable medium described herein, the third information includes an indication of a trust metric associated with the second AI agent, a final result associated with communications between the second AI agent and the first AI agent, information communicated between the first AI agent and the second AI agent, one or more outputs from the one or more verification operations, or any combination thereof.

In some examples of the method, apparatus, and non-transitory computer-readable medium described herein, the first AI agent may be a buyer agent and the second AI agent may be a seller agent.

The following provides an overview of aspects of the present disclosure:
Aspect 1: A method for data processing, comprising: receiving, from a first artificial intelligence (AI) agent, an indication of first information communicated between the first AI agent and a second AI agent; performing one or more verification operations associated with the second AI agent in response to receiving the first information; transmitting, to the first AI agent, an indication of a prompt feature for communication with the second AI agent based at least in part on the first information, the one or more verification operations, or both; receiving, from the first AI agent, second information communicated between the first AI agent and the second AI agent based at least in part on the prompt feature; transmitting, to the first AI agent, a transaction continuance recommendation based at least in part on the second information, the one or more verification operations, or both; and outputting an indication of the second AI agent and third information associated with the second AI agent, wherein the third information is based at least in part on the first information, the second information, the one or more verification operations, the transaction continuance recommendation, or any combination thereof.
Aspect 2: The method of aspect 1, wherein receiving the indication of the first information comprises: receiving an indication of fourth information associated with previous interactions with the second AI agent, the fourth information stored in a database configured to store information associated with previous transactions for a plurality of AI agents that are external to the first AI agent and include the second AI agent.
Aspect 3: The method of any of aspects 1 through 2, further comprising: determining a trust metric associated with the second AI agent based at least in part on a result of the one or more verification operations, the first information, and the second information, wherein the transaction continuance recommendation is based at least in part on the determined trust metric and a threshold trust metric.
Aspect 4: The method of aspect 3, wherein the third information associated with the second AI agent comprises the trust metric.
Aspect 5: The method of any of aspects 1 through 4, wherein performing the one or more verification operations includes one or more of determining whether a domain name associated with the second AI agent comprises one or more irregularities; determining a domain name system reputation associated with the second AI agent; determining a security certificate status associated with the second AI agent; performing a syntactic text search using a large language model (LLM) and a web search engine to determine a risk factor associated with the second AI agent; and determining whether owner information for the domain name associated with the second AI agent comprises one or more irregularities.
Aspect 6: The method of any of aspects 1 through 5, wherein transmitting the indication of the prompt feature comprises: randomly selecting a starter text from a set of starter texts, wherein the prompt feature includes the randomly selected starter text and a request for the second AI agent.
Aspect 7: The method of any of aspects 1 through 6, wherein the transaction continuance recommendation indicates that the first AI agent is to terminate communications with the second AI agent, continue communications with the second AI agent, request more information associated with the second AI agent, or any combination thereof.
Aspect 8: The method of any of aspects 1 through 7, further comprising: receiving, from the first AI agent and based at least in part on the transaction continuance recommendation, a request for the third information associated with the second AI agent, wherein the third information is output to the first AI agent in response to receiving the request.
Aspect 9: The method of any of aspects 1 through 8, wherein outputting the indication of the second AI agent and the third information associated with the second AI agent comprises: storing the third information associated with the second AI agent in a database configured to store information associated with previous transactions for a plurality of AI agents that are external to the first AI agent and include the second AI agent.
Aspect 10: The method of any of aspects 1 through 9, further comprising: receiving, from a third AI agent, an indication of the third information associated with the second AI agent and fourth information communicated between the third AI agent and the second AI agent; and transmitting a second transaction continuance recommendation to the third AI agent based at least in part on receiving the indication of the third information associated with the second AI agent.
Aspect 11: The method of any of aspects 1 through 10, wherein the third information comprises an indication of a trust metric associated with the second AI agent, a final result associated with communications between the second AI agent and the first AI agent, information communicated between the first AI agent and the second AI agent, one or more outputs from the one or more verification operations, or any combination thereof.
Aspect 12: The method of any of aspects 1 through 11, wherein the first AI agent is a buyer agent and the second AI agent is a seller agent.
Aspect 13: An apparatus for data processing, comprising one or more memories storing processor-executable code, and one or more processors coupled with the one or more memories and individually or collectively operable to execute the code to cause the apparatus to perform a method of any of aspects 1 through 12.
Aspect 14: An apparatus for data processing, comprising at least one means for performing a method of any of aspects 1 through 12.
Aspect 15: A non-transitory computer-readable medium storing code for data processing, the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving, from a first artificial intelligence (AI) agent, an indication of first information communicated between the first AI agent and a second AI agent;
performing one or more verification operations associated with the second AI agent in response to receiving the first information;
transmitting, to the first AI agent, an indication of a prompt feature for communication with the second AI agent based at least in part on the first information, the one or more verification operations, or both;
receiving, from the first AI agent, second information communicated between the first AI agent and the second AI agent based at least in part on the prompt feature;
transmitting, to the first AI agent, a transaction continuance recommendation based at least in part on the second information, the one or more verification operations, or both; and
outputting an indication of the second AI agent and third information associated with the second AI agent, wherein the third information is based at least in part on the first information, the second information, the one or more verification operations, the transaction continuance recommendation, or any combination thereof.

2. The method of claim 1, wherein receiving the indication of the first information comprises:
receiving an indication of fourth information associated with previous interactions with the second AI agent, the fourth information stored in a database configured to store information associated with previous transactions for a plurality of AI agents that are external to the first AI agent and include the second AI agent.

3. The method of claim 1, further comprising:
determining a trust metric associated with the second AI agent based at least in part on a result of the one or more verification operations, the first information, and the second information, wherein the transaction continuance recommendation is based at least in part on the determined trust metric and a threshold trust metric.

4. The method of claim 3, wherein the third information associated with the second AI agent comprises the trust metric.

5. The method of claim 1, wherein performing the one or more verification operations includes one or more of:
determining whether a domain name associated with the second AI agent comprises one or more irregularities;
determining a domain name system reputation associated with the second AI agent;
determining a security certificate status associated with the second AI agent;
performing a syntactic text search using a large language model (LLM) and a web search engine to determine a risk factor associated with the second AI agent; and
determining whether owner information for the domain name associated with the second AI agent comprises one or more irregularities.

6. The method of claim 1, wherein transmitting the indication of the prompt feature comprises:
randomly selecting a starter text from a set of starter texts, wherein the prompt feature includes the randomly selected starter text and a request for the second AI agent.

7. The method of claim 1, wherein the transaction continuance recommendation indicates that the first AI agent is to terminate communications with the second AI agent, continue communications with the second AI agent, request more information associated with the second AI agent, or any combination thereof.

8. The method of claim 1, further comprising:
receiving, from the first AI agent and based at least in part on the transaction continuance recommendation, a request for the third information associated with the second AI agent, wherein the third information is output to the first AI agent in response to receiving the request.

9. The method of claim 1, wherein outputting the indication of the second AI agent and the third information associated with the second AI agent comprises:
storing the third information associated with the second AI agent in a database configured to store information associated with previous transactions for a plurality of AI agents that are external to the first AI agent and include the second AI agent.

10. The method of claim 1, further comprising:
receiving, from a third AI agent, an indication of the third information associated with the second AI agent and fourth information communicated between the third AI agent and the second AI agent; and
transmitting a second transaction continuance recommendation to the third AI agent based at least in part on receiving the indication of the third information associated with the second AI agent.

11. The method of claim 1, wherein the third information comprises an indication of a trust metric associated with the second AI agent, a final result associated with communications between the second AI agent and the first AI agent, information communicated between the first AI agent and the second AI agent, one or more outputs from the one or more verification operations, or any combination thereof.

12. The method of claim 1, wherein the first AI agent is a buyer agent and the second AI agent is a seller agent.

13. An apparatus for data processing, comprising:
one or more memories storing processor-executable code; and
one or more processors coupled with the one or more memories and individually or collectively operable to execute the code to cause the apparatus to:
receive, from a first artificial intelligence (AI) agent, an indication of first information communicated between the first AI agent and a second AI agent;
perform one or more verification operations associated with the second AI agent in response to receiving the first information;
transmit, to the first AI agent, an indication of a prompt feature for communication with the second AI agent based at least in part on the first information, the one or more verification operations, or both;
receive, from the first AI agent, second information communicated between the first AI agent and the second AI agent based at least in part on the prompt feature;
transmit, to the first AI agent, a transaction continuance recommendation based at least in part on the second information, the one or more verification operations, or both; and
output an indication of the second AI agent and third information associated with the second AI agent, wherein the third information is based at least in part on the first information, the second information, the one or more verification operations, the transaction continuance recommendation, or any combination thereof.

14. The apparatus of claim 13, wherein, to receive the indication of the first information, the one or more processors are individually or collectively operable to execute the code to cause the apparatus to:
receive an indication of fourth information associated with previous interactions with the second AI agent, the fourth information stored in a database configured to store information associated with previous transactions for a plurality of AI agents that are external to the first AI agent and include the second AI agent.

15. The apparatus of claim 13, wherein the one or more processors are individually or collectively further operable to execute the code to cause the apparatus to:
determine a trust metric associated with the second AI agent based at least in part on a result of the one or more verification operations, the first information, and the second information, wherein the transaction continuance recommendation is based at least in part on the determined trust metric and a threshold trust metric.

16. The apparatus of claim 15, wherein the third information associated with the second AI agent comprises the trust metric.

17. The apparatus of claim 13, wherein:
determining whether a domain name associated with the second AI agent comprises one or more irregularities;
determining a domain name system reputation associated with the second AI agent;
determining a security certificate status associated with the second AI agent;
performing a syntactic text search using a large language model (LLM) and a web search engine to determine a risk factor associated with the second AI agent; and
determining whether owner information for the domain name associated with the second AI agent comprises one or more irregularities.

18. The apparatus of claim 13, wherein, to transmit the indication of the prompt feature, the one or more processors are individually or collectively operable to execute the code to cause the apparatus to:
randomly select a starter text from a set of starter texts, wherein the prompt feature includes the randomly selected starter text and a request for the second AI agent.

19. The apparatus of claim 13, wherein the transaction continuance recommendation indicates that the first AI agent is to terminate communications with the second AI agent, continue communications with the second AI agent, request more information associated with the second AI agent, or any combination thereof.

20. A non-transitory computer-readable medium storing code for data processing, the code comprising instructions executable by one or more processors to:
receive, from a first artificial intelligence (AI) agent, an indication of first information communicated between the first AI agent and a second AI agent;
perform one or more verification operations associated with the second AI agent in response to receiving the first information;
transmit, to the first AI agent, an indication of a prompt feature for communication with the second AI agent based at least in part on the first information, the one or more verification operations, or both;
receive, from the first AI agent, second information communicated between the first AI agent and the second AI agent based at least in part on the prompt feature;
transmit, to the first AI agent, a transaction continuance recommendation based at least in part on the second information, the one or more verification operations, or both; and
output an indication of the second AI agent and third information associated with the second AI agent, wherein the third information is based at least in part on the first information, the second information, the one or more verification operations, the transaction continuance recommendation, or any combination thereof.
